(19) United States
(12) Patent Application Publication
(10) Pub. No.: US 2026/0329962 A1
(43) Pub. Date: Oct. 22, 2026

(54) SYSTEM AND METHOD FOR OPTIMIZATION TAILORED FOR GRAPHICS PROCESSING UNITS

(71) Applicant: CARNEGIE MELLON UNIVERSITY, Pittsburgh, PA (US)

(72) Inventors: Guanglu Zhang, Pittsburgh, PA (US); Jonathan Cagan, Pittsburgh, PA (US); Qihang Shan, Pittsburgh, PA (US)

(73) Assignee: CARNEGIE MELLON UNIVERSITY, Pittsburgh, PA (US)

(21) Appl. No.: 19/643,016

(22) Filed: Apr. 9, 2026

Related U.S. Application Data
(60) Provisional application No. 63/789,825, filed on Apr. 16, 2025.
(60) Provisional application No. 63/836,875, filed on Jul. 1, 2025.

(51) Int. Cl. G06F 17/11

(52) U.S. Cl. CPC G06F 17/11

(57) ABSTRACT

Disclosed herein is a method to enclose the global minimum or maximum of a nonlinear function possibly subject to constraints on the variables. Using interval analysis, coupled with the computational power and architecture of graphics processing units (GPUs), the method iteratively rules out the regions in the search domain where the global minimum or maximum cannot exist and leaves a finite set of regions where the global minimum or maximum must exist.

### RELATED APPLICATIONS

This application claims the benefit of U.S. Provisional Patent Applications Nos. 63/789,825 filed Apr. 16, 2025 and 63/836,875, filed Jul. 1, 2025, the contents of which are hereby incorporated herein in their entireties.

### BACKGROUND

Finding the global minimum or maximum of a nonlinear function possibly subject to constraints on variables, also known as nonlinear optimization, is one of the most fundamental, useful, and difficult mathematical problems. A nonlinear optimization problem is defined as:

minimize ƒ(x) (1)

where ƒ is the nonlinear function, also known as the objective function or loss function, x=[x₁, x₂, . . . , xₙ] represents the n variables, and these variables are possibly subject to one or more constraints:

lᵢ≤xᵢ≤uᵢ, (2)

gⱼ(x)≤0, (3)

hₖ(x)=0, (4)

where i∈{1, 2, . . . , n}, j∈{1, 2, . . . , m}, k∈{1, 2, . . . , p}. The nonlinear function ƒ and the constraint functions g and h have analytic expressions, but they may or may not be continuous and differentiable. In addition, the objective function is possibly highly nonconvex and may have many local minima. Of note, when the objective function is maximized, it could be transformed into the nonlinear optimization problem defined by Eqs. (1-4) by adding a minus sign to the objective function.

The nonlinear optimization problem defined by Eqs. (1-4) is pervasive in many science and engineering fields. In many practical applications, it is desirable, and sometimes indispensable, to find the global minimum (or maximum) of a nonlinear function. Popular numerical optimization methods include but are not limited to gradient-based methods (e.g., gradient descent methods interior-point methods, trust region methods, and BFGS methods, heuristic methods (e.g., genetic algorithms, simulated annealing, particle swarm optimization, and tabu search), and global optimization methods based on regular floating-point arithmetic (e.g., Nelder-Mead methods, DIRECT methods, basin-hopping, and differential evolution).

These methods, however, often fail to find the global minimum or maximum of a nonlinear function. This is because these popular numerical optimization methods suffer from at least one of the following three limitations: (1) The convergence of some popular numerical optimization methods relies on an appropriate initial guess. The users of these methods must guess or randomly select the initial value(s) of each variable, also known as the starting point(s), to initialize these methods. A poor initial guess can contribute to the non-convergence of these methods or lead these methods to converge to an inferior solution; (2) These numerical optimization methods often become trapped in a local minimum or maximum. When the initial guess and the stopping criteria are properly specified, these methods may converge to a local minimum or maximum of the nonlinear function. However, the nonlinear function may have many local minima or maxima. Even if these methods are run multiple times with different initial guesses, the users are still not able to know whether the global minimum or maximum is found, and thus, it is difficult for the users to determine when to stop the search process using these methods; and (3) Many numerical optimization methods do not take rounding errors into account. When the nonlinear function is evaluated during the iteration process of these methods, the numerical result of each floating-point arithmetic operation is usually rounded to its closest binary machine number. Because the evaluation of a nonlinear function often consists of multiple floating-point arithmetic operations, the accumulation of rounding errors could lead to incorrect function evaluation results and wrong solutions.

Based on the limitations of these popular numerical optimization methods, several global optimization methods using interval analysis, referred to here as existing interval methods, have been introduced to enclose the global minimum or maximum of a nonlinear function possibly subject to constraints on variables. However, because these existing interval methods employ interval Newton methods and/or consistency techniques (e.g., box consistency and hull consistency) during their iteration process, they usually require the objective and constraint functions to be continuous and differentiable, and the users often need to transform these functions into different forms on a case-by-case basis. In addition, these existing interval methods are significantly more computationally expensive than the popular numerical optimization methods discussed above.

As a result, these existing interval methods are not commonly adopted for nonlinear optimization in practical applications, especially for large-scale nonlinear optimization that have more than 100 dimensions (i.e., the vector x in Eq. (1) includes more than 100 variables) and many local minima or maxima. Importantly, the recent advances in graphics processing units (GPUs) have brought unprecedented computational power to users, offering new opportunities to overcome the computational bottleneck in nonlinear optimization using interval analysis. Unfortunately, existing interval methods cannot utilize the computational power of GPUs, because modern GPUs are designed for massively parallel computing with a unique compute and memory architecture, but existing interval methods are designed for central processing unit (CPU)-based sequential computing, making these methods difficult to achieve massively parallel computing based on GPU architecture.

### SUMMARY OF THE INVENTION

Disclosed herein is a numerical method to enclose the global minimum or maximum of a nonlinear function possibly subject to constraints on the variables. Using interval analysis, coupled with the computational power and architecture of graphics processing units (GPUs), the method iteratively rules out the regions in the search domain where the global minimum or maximum cannot exist and leaves a finite set of regions where the global minimum or maximum must exist.

In the method disclosed herein, interval analysis, coupled with the computational power and architecture of GPU, are leveraged to implement a numerical method that is guaranteed to enclose the global minimum or maximum of a nonlinear function possibly subject to constraints on variables, especially a large-scale nonconvex nonlinear function that has more than 100 variables, in a reasonable computation time. Instead of extending or accelerating any existing CPU-based numerical optimization methods using a GPU, the disclosed method is originally tailored for execution on a GPU, and the design and implementation of the method are intertwined based on GPU architecture. In other words, the method is a GPU-based method rather than a GPU-accelerated method. The method employs a novel GPU-based single program, single data parallel programming style to circumvent major GPU performance bottlenecks, and a variable cycling technique is also integrated into the method to reduce computational cost when solving large-scale nonlinear optimization problems.

In contrast to the limitations of existing numerical methods for nonlinear optimization, the disclosed method is a general, complete, optimization method having the following four features.

Generality: The method does not require the objective and constraint functions to be continuous or differentiable, and the users do not need to transform these functions into different forms. The allowable range of each variable in Eq. (2) could be [−∞, +∞] because the method uses a closed interval system.

Completeness: The method encloses the global minimum or maximum of a nonlinear function possibly subject to constraints on variables with certainty. The method finds all the n-dimensional regions (based on user-specified region size tolerances) in the search domain where the global minimum or global maximum must exist after a finite computation time.

Rigorousness: The method is guaranteed to enclose the global minimum or maximum even in the presence of rounding errors. The method also provides computer-aided proof for the existence of the global minimum or maximum in the search domain.

Efficiency: The method is tailored for implementation on a GPU based on GPU compute and memory architecture. Importantly, the method employs a novel GPU-based single program, single data (SPSD) parallel programming style (belonging to the multiple instruction stream, single data stream (MISD) class based on Flynn's taxonomy) to circumvent two major GPU performance bottlenecks, CPU-GPU data transfers and GPU global memory access. In addition, a variable cycling technique is integrated into the method to reduce computational cost when solving large-scale nonlinear optimization problems.

The disclosed method completely searches the feasible domain and successfully encloses the guaranteed global minimum or maximum of a nonlinear function possibly subject to constraints on variables, especially large-scale nonlinear functions that have more than 100 variables.

### BRIEF DESCRIPTION OF THE DRAWINGS

By way of example, specific exemplary embodiments of the disclosed system and method will now be described, with reference to the accompanying drawings, in which:

FIG. 1 is a schematic representation of the different types of memory inherent in a GPU.

FIG. 2 is a flowchart showing the disclosed method of the present invention.

FIGS. 3(A-B) graphically show the sampling and ruling out process for one iotation of the method.

FIG. 4A illustrates the partitioning of a selected region into 16 subregions.

FIG. 4B illustrates the computation of the subregion indices.

### DETAILED DESCRIPTION

### GPU Architecture and Limitations

To understand how the disclosed method is tailored for execution on one or more GPUs, GPU architecture and performance bottlenecks will first be discussed. Modern GPUs have brought terascale computing (the ability to perform at least 10¹² calculations per second) to personal laptops and desktops and exascale computing (the ability to perform at least 10¹⁸ calculations per second) to multi-user servers and clusters, which enables applications that previously could not be achieved because of long execution times. Unlike the CPU, which excels at executing a sequence of instructions (known as a thread) as fast as possible, the GPU excels at executing many threads in parallel and realizes unprecedented computational power through its unique compute and memory architecture. The method disclosed herein is designed and implemented based on GPU compute and memory architecture.

For GPU compute architecture based on the popular Compute Unified Device Architecture (CUDA), threads are organized into a two-level hierarchy, where a grid includes many blocks, with each block including up to 1024 threads. A modern GPU contains several Streaming Multiprocessors (SMs), and each SM has many cores (also known as processing units or shading units).

When threads are assigned to SMs on a GPU, all threads in the same block are assigned to one SM at the same time, and these threads in the same block are further divided into 32-thread units called warps. All threads in a warp always execute the same instruction at any point in time. To efficiently utilize the computational power of a GPU, it is essential to achieve high GPU occupancy by assigning more threads to an SM than the number of cores on the SM. In that way, multiple warps can share the same cores on the SM. Specifically, when a warp needs to wait for the result from a long-latency operation, the GPU could select another warp that is ready for execution to use the cores on the SM. In practice, GPU occupancy is calculated as the ratio of the number of active warps on an SM to the maximum number of active warps supported by the SM. To achieve the full occupancy of a GPU, it is necessary to saturate all the SMs by assigning the GPU the theoretical maximum number of active threads that could be supported by the GPU, and the execution of these threads must also satisfy other resource constraints, such as registers and shared memory usages. The theoretical maximum number of active threads could be calculated based on the configuration and compute capability of the GPU. For example, an NVIDIA H100 GPU with the compute capability 9.0 contains 114 SMs, wherein each SM has 128 cores and supports up to 64 active warps (2,048 threads). To achieve the full occupancy of the NVIDIA H100 GPU, it is necessary to assign at least 233,472 threads (7,296 warps) to the GPU at the same time.

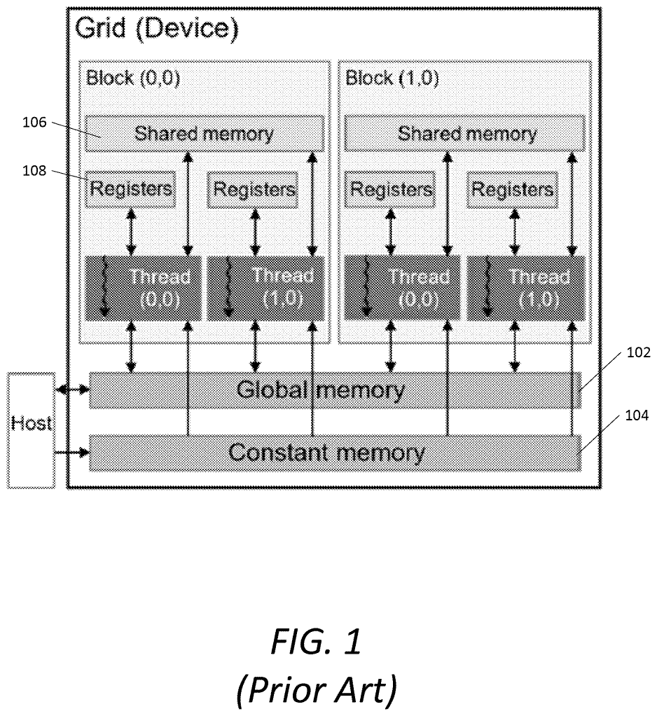

For GPU memory architecture based on CUDA, each thread can access several types of memories on the GPU. As shown in FIG. 1, four types of commonly used GPU memories are provided. Global memory 102 provides read-and-write access for all threads in the grid with long access latency and finite access bandwidth. Global memory usually has a storage capacity of several gigabytes (GB). Constant memory 104 provides read-only access for all threads in the grid with short access latency and high access bandwidth. In many modern GPUs, the storage capacity of constant memory is 64 kilobytes (KB). Shared memory 106 provides read-and-write access for threads in the same block and can be accessed at very high speed. Shared memory usually has a storage capacity of tens or hundreds of kilobytes (KB). Registers 108 provide read-and-write access for individual threads and feed directly into the cores on the SM. Each register typically has a storage capacity of 32 bits.

Modern GPUs have this unique compute and memory architecture because they are designed for massively parallel computing. As a result, GPU computing is not preferable for all applications. In practice, many applications of GPU computing are based on data parallelism, where the computational work to be performed on different portions of a dataset can be done independently. In these applications, each thread uses its corresponding block index and thread index, which are built-in variables in CUDA, to identify the appropriate portion of the dataset to process, and all threads execute the same code, known as a kernel function. These applications are instances of the single program, multiple data (SPMD) parallel programming style, which belongs to the multiple instruction stream, multiple data stream (MIMD) class based on Flynn's taxonomy. Of note, because data parallelism does not exist in existing interval methods for nonlinear optimization, these existing interval methods cannot use the SPMD parallel programming style, and GPU computing has not been commonly adopted for nonlinear optimization using interval analysis in practice yet.

Importantly, even in applications that could use the SPMD parallel programming style, GPU computing often suffers from two major performance bottlenecks: CPU-GPU data transfers and GPU global memory access. In typical GPU computing applications using the SPMD parallel programming style, a large amount of data (e.g., several GB) often needs to be transferred between CPU and GPU global memory, and such data transfers are time-consuming. In addition, GPU global memory has long access latency and finite access bandwidth; therefore, it is slow to read and write a large amount of data on GPU global memory. Although several strategies have been introduced to reduce GPU global memory access, such as coalescing global memory access and placing reused data on GPU shared memory or registers, it is often difficult to circumvent both of these two major performance bottlenecks, especially CPU-GPU data transfers, in typical GPU computing applications using the SPMD parallel programming style.

### Interval Analysis

Because the method disclosed herein is based on interval analysis, a brief overview is provided for better understanding of the method. Interval analysis, also known as interval arithmetic or interval computation, is a mathematical technique that provides rigorous bounds for the results of numerical computations. In interval analysis, each variable is represented by an interval argument, [a, b]={x: a≤x≤b}, where a and b denote the lower and upper bounds for the value of the variable x, respectively. Four basic interval arithmetic operations (interval addition, subtraction, multiplication, and division) are defined in Eqs. (3)-(6) for demonstration purposes:

$$[ {x}_{1} , {x}_{2} ] + [ {y}_{1} , {y}_{2} ] = [ {x}_{1} + {y}_{1} , {x}_{2} + {y}_{2} ] \qquad ( 5 )$$

$$[ {x}_{1} , {x}_{2} ] - [ {y}_{1} , {y}_{2} ] = [ {x}_{1} - {y}_{2} , {x}_{2} - {y}_{1} ] \qquad ( 6 )$$

$$[ {x}_{1} , {x}_{2} ] \cdot [ {y}_{1} , {y}_{2} ] = [ min \{ {x}_{1} {y}_{1} , {x}_{1} {y}_{2} , {x}_{2} {y}_{1} , {x}_{2} {y}_{2} \} , max \{ {x}_{1} {y}_{1} , {x}_{1} {y}_{2} , {x}_{2} {y}_{1} , {x}_{2} {y}_{2} \} ] \qquad ( 7 )$$

$$\frac{[ {x}_{1} , {x}_{2} ]}{[ {y}_{1} , {y}_{2} ]} = [ {x}_{1} , {x}_{2} ] \cdot \frac{1}{[ {y}_{1} , {y}_{2} ]} \qquad ( 8 )$$

Unlike floating-point arithmetic operations that round the numerical result of each arithmetic operation to its closest binary machine number, interval arithmetic operations implement outward rounding to provide rigorous bounds for the result of each arithmetic operation. In optimal outward rounding, the outwardly rounded lower bound (left endpoint) is the closest machine number less than or equal to the exact lower bound, and the outwardly rounded upper bound (right endpoint) is the closest machine number greater than or equal to the exact upper bound. In practice, users can also specify their desired significant digits for outward rounding. For example, the interval [3.16, 3.87] could be outwardly rounded as [3.1, 3.9] with two significant digits.

Interval evaluation of a mathematical function (i.e., evaluation of a mathematical function through a series of interval arithmetic operations) has been proven to provide rigorous bounds for the value of the mathematical function, even when the mathematical function is non-convex. In other words, when a mathematical function is evaluated with a specified interval argument for each variable, replacing each floating-point arithmetic operation with its corresponding interval arithmetic operation yields a lower bound and an upper bound for the value of the mathematical function, and all possible values of the mathematical function with the specified interval arguments are guaranteed to be included in the range defined by the lower and upper bounds. However, many interval evaluations that include multiple interval arithmetic operations suffer from the dependence problem, also known as interval dependency, and the dependence problem results in overestimated bounds for the value of the mathematical function (i.e., an interval with unwanted excess width). For example, for the mathematical function ƒ(x)=x−x², where x∈[0,1], the exact range of the function value is [0, 0.25]; the interval arithmetic operations defined in Eq. (6) and Eq. (7) give [0, 1]−[0, 1]·[0, 1]=[−1,1] where the result [−1,1] includes the exact range [0,0.25] but it has a significant excess width. Such overestimated bounds are generated because each occurrence of the variable x is treated as a different variable in the interval evaluation. Importantly, if every variable occurs only once in a mathematical function, the interval evaluation of the function gives the exact range of the function, but when any variable occurs more than once in a mathematical function, the dependence problem often occurs. Several approaches have been introduced to derive exact bounds or at least narrower bounds for the value of a mathematical function when evaluating the function using interval arithmetic operations. One major approach is to transform the function into another form, such as a form where every variable only occurs once (if possible), the centered form, the mean value form, or a Taylor series. In the example above, the mathematical function could be transformed as ƒ(x)=x−x²=(x−0.5)²+0.25, and the interval evaluation of the transformed function yields the exact range [0, 0.25].

Another approach, known as splitting or refinement, is to divide the range of each variable in a mathematical function into many subintervals and then take the union of the interval evaluations over these subintervals. It has been proven that the union of these interval evaluations converges to the exact range of the mathematical function when the number of subintervals approaches positive infinity. In the example above, when the range x∈[0,1] is uniformly divided into 1,000 subintervals, the union of the 1,000 interval evaluations of the mathematical function ƒ(x)=x−x² over these subintervals gives [−0.001, 0.251], which is close to the exact range [0, 0.25]. Interval analysis has been extensively employed in computer-aided proofs in mathematical analysis.

Several numerical methods using interval analysis (referred to here as existing interval methods) have also been introduced for nonlinear optimization. These existing interval methods often rely on a branch-and-bound process, also known as a branch-and-prune process or a branch-and-reduce process, to compute the guaranteed bound on the global minimum or maximum of the objective function and the corresponding bounds on the value of each variable. Despite several successful applications, these existing interval methods are not commonly adopted for nonlinear optimization in practical applications, especially for large-scale nonlinear optimization, because these methods have two major limitations. First, existing interval methods are not generally applicable to nonlinear optimization. These methods usually employ interval Newton methods and/or consistency techniques (e.g., box consistency and hull consistency) during their iteration process. As a result, these methods usually require the objective and constraint functions to be continuous and differentiable, and the users often need to transform each function into a different form on a case-by-case basis. Second, existing interval methods are designed for CPU-based sequential computing, and they are significantly more computationally expensive than popular numerical optimization methods, such as gradient-based methods and heuristic methods. Recent advances in GPUs offer new opportunities to overcome the computational bottleneck in nonlinear optimization using interval analysis. Importantly, many personal laptops and desktops are now equipped with a dedicated GPU. Many companies and research institutions are also operating clusters and supercomputers with over 10,000 GPUs. However, because GPUs are designed for massively parallel computing with unique compute and memory architecture, these existing interval methods designed for CPU sequential computing cannot utilize the computational power and architecture of the GPU.

### The Method

Disclosed herein is a GPU-based numerical method for nonlinear optimization. Using interval analysis, coupled with the computational power and architecture of GPU, the method is guaranteed to enclose the global minimum or maximum of a nonlinear function possibly subject to constraints on variables, especially a large-scale non-convex nonlinear function that has more than 100 variables, in a reasonable computation time, even in the presence of rounding errors. Importantly, the method does not endeavor to accelerate any existing interval methods (existing nonlinear optimization methods using interval analysis) using GPU. Instead, the method is originally designed and implemented for the GPU based on the GPU compute and memory architecture.

The objective function to be minimized or maximized is specified by the user based on their practical applications. For example, the objective function could be the total design and manufacturing cost of a launch vehicle, the energy lost during transmission and distribution of a power grid, or the product yield of a chemical reactor. As long as the objective and constraint function have analytic expressions, the method can enclose the guaranteed global minimum/maximum of the objective function. In one embodiment, the users enter the mathematical expression of each objective and constraint function. Alternatively, the sequence of arithmetic operations to evaluate each objective and constraint function could be defined automatically by the software or manually by the users.

The method has three unique features. First, the method partitions a selected region in the search domain into many subregions in each iteration based on the configuration and compute capability of the user's GPU(s), and each thread in GPU computing processes the same computational task corresponding to one or more subregions independently to determine whether the global minimum or maximum is impossible to exist in the subregion, achieving massively parallel computing based on GPU compute architecture.

Second, a novel GPU-based single program, single data (SPSD) parallel programming style is introduced and employed for GPU computing in each iteration to circumvent two major GPU performance bottlenecks, CPU-GPU data transfers and GPU global memory access, utilizing GPU computational power efficiently based on GPU memory architecture.

Third, when solving large-scale nonlinear optimization problems that have more than 100 dimensions, the selected region in the search domain is partitioned using a variable cycling technique, where the selected region is partitioned in a portion of its n dimensions in each iteration in a cyclic manner, significantly reducing the computational cost during the iteration process.

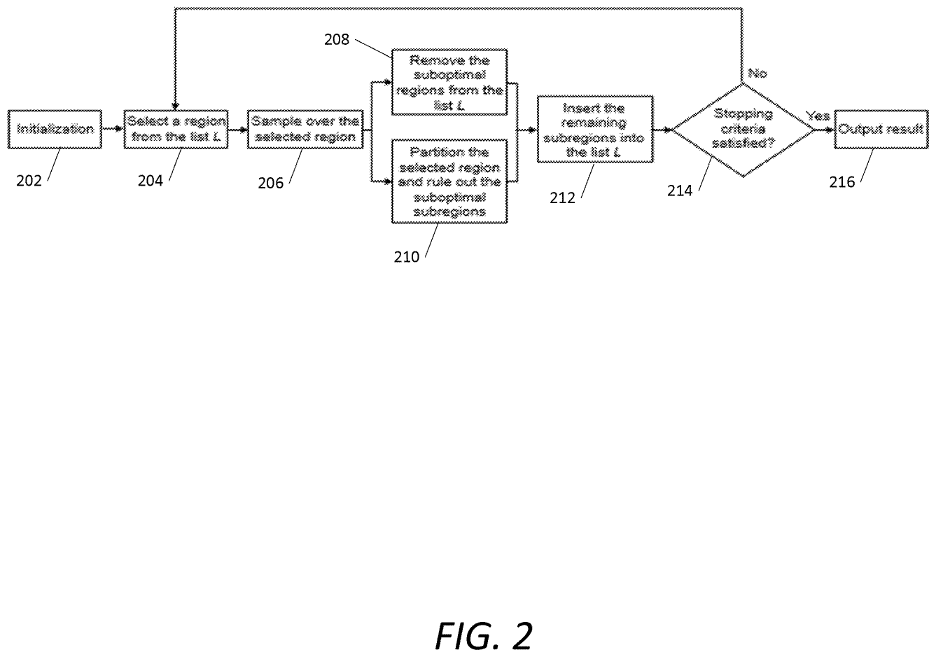

The method is realized by iteratively ruling out the regions in the search domain where the global minimum or maximum cannot exist, referred to as the suboptimal regions, and leaving a finite set of regions where the global minimum or maximum must exist. A flowchart of the method is illustrated in FIG. 2 to solve the nonlinear optimization problem defined by Eqs. (1-4), where the objective function ƒ(x) is minimized. When the objective function ƒ(x) is maximized, it could be transformed into the nonlinear minimization problem defined by Eqs. (1-4) by adding a minus sign to the objective function. Each step in the flowchart is described as follows:

Initialization (202): To initialize the iterative process, the n-dimensional search domain, also known as the feasible set, is specified by the allowable range of each variable defined in Eq. (2). A list L is also created to store the regions (n-dimensional “boxes”) in the search domain where the global minimum must exist. List L is initialized with a single region that covers the whole search domain.

Select a region from list L (204): At the beginning of each iteration, among all regions in the list L, the region with the smallest lower bound for the value of the objective function in the region is selected and removed from list L, where the lower bound for the value of the objective function in each region in list L is derived by GPU computing in the previous iterations. Of note, that region is selected from list L because it has a better chance of including the global minimum of the nonlinear function than other regions in list L. Other user-specified strategies, such as selecting the first or last region in the list or randomly selecting a region from the list, also could be employed to select a region from list L in this step.

Sample over the selected region (206): One or more sample points are then chosen from the selected region based on a user-specified sampling strategy. Popular sampling techniques, also known as designs for computational experiments, such as simple grids, maximum entropy designs, mean squared-error designs, Latin hypercubes, and randomized orthogonal arrays, could be employed to choose sample points in the selected region. Popular gradient-based methods (e.g., interior-point methods and trust region methods) and heuristic methods (e.g., genetic algorithms and simulated annealing) could also be employed to minimize the nonlinear function in the selected region, and their solutions could be used as sample points in the selected region. The objective and constraint functions are evaluated using interval analysis at each of these sample points, and such interval evaluation yields the lower and upper bounds for the value of each objective and constraint function at each sample point. Among all feasible sample points that satisfy all constraints in the selected region, the smallest upper bound for the value of the objective function is used to update the upper bound of the global minimum over the whole search domain, denoted by GUB. In other words, the GUB value is derived by interval evaluation of the objective function at the best available feasible sample point chosen in all previous iterations and the current iteration, and the global minimum of the objective function is guaranteed to be smaller than or equal to the GUB value. In the following steps in the current iteration, the updated GUB value is used to rule out the suboptimal regions in the search domain where the global minimum cannot exist. Therefore, if a smaller GUB value is efficiently computed through sampling over the selected region, more suboptimal regions could be ruled out in the current iteration. However, it is not necessary to reduce the GUB value at a high computational cost (e.g., by choosing a large number of sample points or running a heuristic method with a huge population size in the selected region) in the current iteration because the GUB value will be updated in each of the following iterations. In other words, any sampling strategy is acceptable to use in this step, including choosing a single random point in the selected region, but the popular sampling techniques and optimization methods could result in longer computation times in this step, with potential reduction in the total number of iterations, thus reducing the overall computation time of the method. Importantly, the goal of sampling over the selected region in this step is to update the upper bound of the global minimum over the whole search domain, denoted by GUB. The GPU value also could be updated by other techniques, such as using the upper bound for the value of the objective function in any feasible region in the search domain, instead of sampling over the selected region.

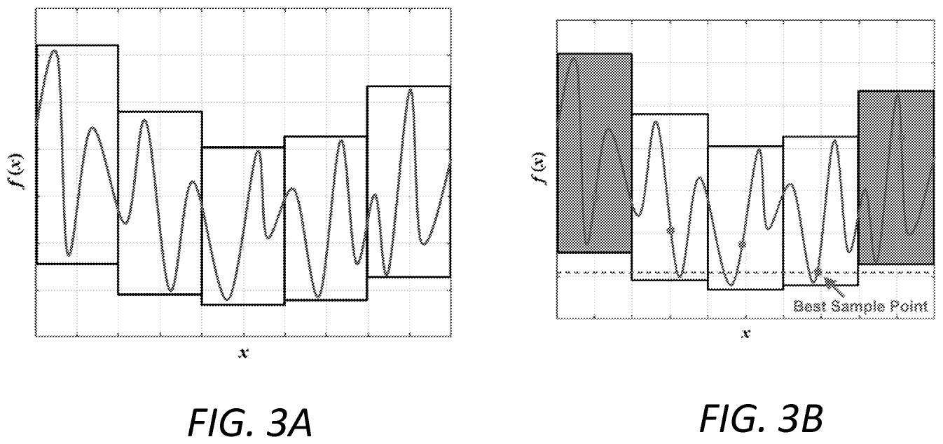

FIGS. 3(A,B) show the sampling and ruling out process for one iteration of the method. As shown in FIG. 3A, rigorous lower and upper bounds for the value of the objective function in each subregion are derived from interval evaluation of the objective function in each subregion. FIG. 3B shows the ruling out process, wherein the suboptimal subregions (shaded) are ruled out based on the best sample point being lower than the lower bound for the value of the objective function in each of the shaded subregions, as determined by interval evaluation of the objective function.

Remove the suboptimal regions from list L (208): Using the updated GUB value derived from sampling over the selected region or from other techniques, the suboptimal regions in list L, where the global minimum cannot exist, are ruled out and removed from list L. A region in list L is labeled as a suboptimal region and removed from list L if the lower bound for the value of the objective function in the region is larger than the updated GUB value. In other words, the value of the objective function in the region is guaranteed to be larger than that at the best sample point found so far, and therefore, the global minimum is impossible to exist in the region.

Partition the selected region and rule out the suboptimal subregions (210): The selected region is partitioned into many subregions, and the suboptimal subregions in the selected region, where the global minimum cannot exist, are ruled out using the updated GUB value. Specifically, the selected region is partitioned into many subregions based on a user-specified partition strategy, such as uniform partition and golden ratio partition. Different scales and coordinate systems could be employed in the partition strategy if necessary. For example, for a 10-dimensional selected region defined by xᵢ∈[1, 10⁸], where i={1, 2, . . . , 10}, using a uniform partition strategy on a logarithmic scale, the range of each variable in the selected region, [1, 10⁸], could be divided into four subintervals, [1, 10²], [10², 10⁴], [10⁴, 10⁶] and [10⁶, 10⁸], and the selected region is partitioned into 4¹⁰=1,048,576 subregions. The objective function is evaluated using interval analysis in all subregions derived from the partition. These interval evaluations yield the lower and upper bounds for the value of the objective function in each subregion. Importantly, as long as the objective function defined in Eq. (1) has a analytic expression, all possible values of the objective function in a subregion are guaranteed to be included in the range defined by the lower and upper bounds, even if the objective function includes narrow spikes in the subregion. If the lower bound for the value of the objective function in a subregion is larger than the updated GUB value, the subregion is labeled as a suboptimal subregion, where the global minimum cannot exist. Importantly, if the selected region is partitioned in all its n dimensions as shown in the example above, both the number of subregions derived from the partition and the GPU computational cost to analyze these subregions increase exponentially with the dimension of the nonlinear function (known as the curse of dimensionality). To circumvent the curse of dimensionality, a variable cycling technique is introduced later herein, and the integration of the variable cycling technique into the method enables the method to efficiently solve large-scale nonlinear optimization problems that have more than 100 dimensions.

When the nonlinear optimization problem has one or more inequality and/or equality constraints as defined in Eq. (3) and Eq. (4), the suboptimal subregions in the selected region, where the global minimum cannot exist, also can be ruled out based on constraint satisfaction. Specifically, the interval evaluation of each inequality constraint function, gⱼ(x) in Eq. (3), within each subregion yields the guaranteed lower and upper bounds for the value of the inequality constraint function within the corresponding subregion, denoted by

$$L {B}_{{g}_{j}}^{( r )} and {UB}_{{g}_{j}}^{( r )} , where j ∈ \{ 1 , 2 , … , m \} , r ∈ \{ 0 , 1 , … , t - 1 \} ,$$

and t is the total number of subregions derived from the partition of the selected region. For any

$$j ∈ \{ 1 , 2 , … , m \} , if {LB}_{{g}_{j}}^{( r )} > 0$$

in a subregion, all possible values of the inequality objective function within the subregion cannot satisfy the corresponding inequality constraint, and the subregion is ruled out.

Similarly, the interval evaluation of each equality constraint function, hₖ(x) in Eq. (4), within each subregion yields the guaranteed lower and upper bounds for the value of the equality constraint function within the corresponding subregion, denoted by

$${LB}_{{h}_{k}}^{( r )} and {UB}_{{h}_{k}}^{( r )} , where k ∈ \{ 1 , 2 , … , p \} and r ∈ \{ 0 , 1 , … , t - 1 \} .$$

For any k∈{1, 2, . . . , p}, if

$$L {B}_{{h}_{k}}^{( r )} > 0 or {UB}_{{h}_{k}}^{( r )} < 0$$

in a subregion, all possible values of the equality objective function within the subregion cannot satisfy the corresponding equality constraint, and the subregion is ruled out.

The ruling-out processes stated in the last few paragraphs using the updated GUB value and the constraint satisfaction are generally applicable and do not require the objective and constraint functions to be continuous or differentiable. When the objective function is a continuous and first-order differentiable function, the first-order derivatives of the objective function can also be used to rule out suboptimal subregions in the selected region. Specifically, the interval evaluation of each first-order derivative of the objective function, ∂ƒ(x)/∂xᵢ, within each subregion yields the guaranteed lower and upper bounds for the value of the derivative within the corresponding subregion, denoted by

$${LB}_{{df}_{i}}^{( r )} and {UB}_{{df}_{i}}^{( r )} , where i ∈ \{ 1 , 2 , … , n \} and r ∈ \{ 0 , 1 , … , t - 1 \} .$$

For any i∈{1, 2, . . . , n}, if the first-order derivative of the objective function is impossible to be zero in the subregion (i.e.,

$$L {B}_{{df}_{i}}^{( r )} > 0 or {UB}_{{df}_{i}}^{( r )} < 0$$

in the subregion) and all constraints including the corresponding variable are not active in the subregion (i.e., for the corresponding

$${x}_{i} , {I}_{i} < {x}_{i} < {u}_{i} and {UB}_{{g}_{j}}^{( r )} < 0$$

for all gⱼ(x) that include the xᵢ in the subregion), all possible values of the objective function within the subregion cannot satisfy the necessary first-order optimality conditions for local minima, commonly known as the Karush-Kuhn-Tucker conditions in nonlinear optimization, and the subregion is ruled out.

Insert the remaining subregions into list L (212): After the suboptimal subregions are ruled out from the selected region based on the updated GUB value, the constraint satisfaction (if available), and the first-order derivatives of the objective function (if available), the remaining subregions (i.e., the subregions that are not labeled as suboptimal subregions) in the selected region, where the global minimum may exist, are inserted into list L for further analysis in the following iterations. Of note, some or all of these remaining regions could be combined as one or multiple regions based on a user-specified combination criterion before they are inserted into list L. Importantly, the two parallel steps shown in the flowchart in FIG. 2 only rule out the regions in the search domain where the global minimum is impossible to exist. As a result, the global minimum of the objective function in the search domain is guaranteed to be included in the regions in list L during the whole iteration process.

Stopping criteria satisfied? (214): At the end of each iteration, the method checks whether each user-specified stopping criterion is satisfied. If all stopping criteria are satisfied, the iteration process is halted. Otherwise, a new iteration begins at step 204, and among all regions in updated list L, one region is selected and removed from list L for analysis. One or multiple stopping criteria could be specified based on the available computational resources and the practical needs of the user. For example, the stopping criteria could be specified based on the computer run time, the maximum number of iterations, and the region size tolerance (e.g., the interval width in a specific dimension or all dimensions among all the regions in list L).

Output result (216): Once the iteration process is halted, the method outputs all the regions in list L, and the global minimum is guaranteed to be included in these regions. The method also outputs the lower and upper bounds for the value of the global minimum, denoted by GLB and GUB, and the value of the global minimum is guaranteed to be included in the interval [GLB, GUB]. The GLB value is the smallest lower bound for the value of the objective function in all the regions in list L. The GUB value is the updated GUB value derived from the last iteration.

### Implementation of the Method

In each iteration of the method, the key step is to partition the selected region into many subregions and rule out suboptimal subregions, where the global minimum cannot exist. This key step is realized through the execution of a kernel function, where each GPU computing thread evaluates the objective function, the constraint functions (if available), and the first-order derivatives of the objective function (if available) in one or more corresponding subregions using interval analysis independently. To efficiently utilize the computational power of the user's GPU(s), the kernel function is implemented based on GPU compute and memory architecture. In addition, a variable cycling technique is integrated into the kernel function for solving large-scale nonlinear optimization problems that have more than 100 dimensions. Moreover, a data representation with limited memory usage is employed for each region in list L to avoid host RAM overflow.

To achieve high GPU occupancy based on the GPU compute architecture, the number of subregions derived from the partition of the selected region is determined based on the configuration and compute capability of the user's GPU(s). Specifically, because each thread in GPU computing corresponds to one or more subregions, it is necessary to derive an appropriate number of subregions from the partition to saturate the SMs of the user's GPU(s). In practice, the theoretical maximum number of active threads that could be supported by the user's GPU(s) serves as a reference value for the number of subregions. For example, when each thread in GPU computing corresponds to one subregion, for a server with eight NVIDIA H100 GPUs, at least 1,867,776 subregions need to be derived from the partition of the selected region to achieve the full occupancy of these eight GPUs. If the number of subregions derived from the partition is significantly larger (e.g., more than two orders of magnitude larger) than the reference value, a large portion of the threads will be executed in sequential computing rather than in parallel computing, leading to a long execution time. If the number of subregions derived from the partition is significantly smaller (e.g., less than the total number of cores on the user's GPU(s)) than the reference value, many GPU cores will become idle during the execution of the kernel function, leading to GPU underutilization. In addition, because 32 threads in a warp are always scheduled to execute the same instruction at the same time in GPU computing, it is beneficial to choose the number of subregions derived from the partition as a multiple of 32.

To circumvent two major GPU performance bottlenecks (CPU-GPU data transfers and GPU global memory access) based on GPU memory architecture, a novel GPU-based single program, single data (SPSD) parallel programming style is employed in the implementation of the kernel function. Specifically, to evaluate the objective function, the constraint functions (if available), and the first-order derivatives of the objective function (if available) in each subregion using interval analysis, the data set that each thread in GPU computing needs to use is the location of its corresponding subregion(s) in the search domain. The location of a subregion in the search domain is represented by the lower and upper bounds for the value of each variable in the subregion, denoted by

$$\underline{{x}_{i}^{( r )}} and \overline{{x}_{i}^{( r )}} ,$$

respectively, where i∈{1, 2, . . . , n}, r∈{0, 1, . . . , t−1} in the subregion.

If the common single program, multiple data (SPMD) parallel programming style is employed, the selected region needs to be partitioned into many subregions on CPU, and the location data of these subregions in the search domain (2×n×t floating-point numbers) are transferred to GPU global memory. Each thread in GPU computing identifies its corresponding subregion(s) using its block index and thread index, and each thread reads its corresponding subregion location data from GPU global memory.

Importantly, the implementation of the kernel function based on the common SPMD parallel programming style suffers from the two major GPU performance bottlenecks because it requires a large amount of data transfer from CPU to GPU and many GPU global memory reads at the beginning of the kernel function execution. To circumvent these GPU performance bottlenecks, a GPU-based single program, single data (SPSD) parallel programming style is introduced and employed. Using the GPU-based SPSD parallel programming style, only the location of the selected region (2×n floating-point numbers) is transferred to GPU constant memory. The selected region is partitioned on GPU, and each thread computes its corresponding subregion location using its block index, thread index, and the location of the selected region. As an example, when solving a two-dimensional nonlinear optimization problem (n=2) and each thread in GPU computing corresponds to one subregion, the selected region in the current iteration is defined by

$${x}_{1} ∈ [ \underline{{x}_{1}^{select}} , \overline{{x}_{1}^{select}} ] and {x}_{2} ∈ [ \underline{{x}_{2}^{select}} , \overline{{x}_{2}^{select}} ] ,$$

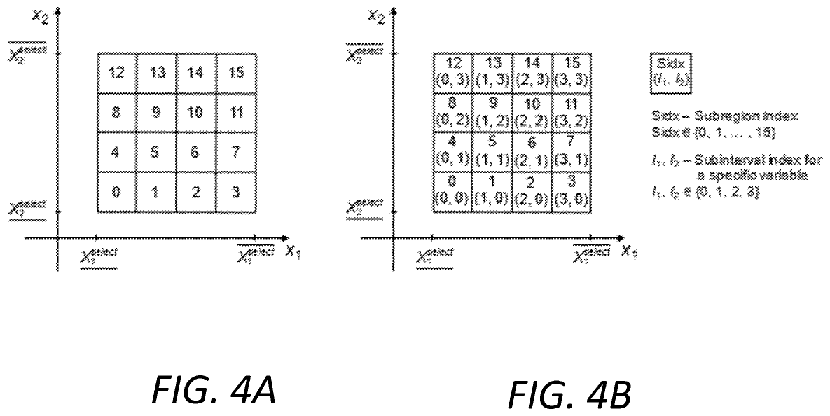

and the range of each variable in the selected region is uniformly divided into four subintervals, resulting in 16 subregions in total (t=16). As illustrated in FIG. 4A, each subregion is assigned a subregion index, denoted by Sidx, and Sidx∈{0, 1, . . . , 15} in this example. Each thread in GPU computing has its unique index in the grid, also known as the absolute position of the thread in the entire grid of blocks, and the unique index r of each thread is derived by:

r=threadldx.x+blockldx.x×blockDim.x (9)

Where threadldx.x is the thread index, blockldx.x is the block index, blockDim.x is the block size (i.e., the number of threads in a block), and one-dimensional grid and blocks are used in this example.

The thread index and block index are two built-in variables in CUDA, and the block size is a constant specified by the user when the kernel function is launched. The unique index of each thread in the grid is mapped to the subregion index. In other words, a thread with the unique index of r in the grid corresponds to the subregion with Sidx=r. As shown in FIG. 4B, the subinterval indices of each subregion, denoted by

$${l}_{1}^{( r )} and {l}_{2}^{( r )}$$

in this example are computed by:

$${l}_{1}^{( r )} = r \% 4 \qquad ( 10 )$$

$${l}_{2}^{( r )} = r // 4 \qquad ( 11 )$$

where “%” in Eq. (10) represents a modulo operation that returns the remainder of a division, and “//” in Eq. (11) represents a floor division operation that performs a division and rounds the result down to the nearest integer. The location of a subregion in the search domain, represented by

$$\underline{{x}_{i}^{( r )}} and \overline{{x}_{i}^{( r )}} ,$$

is computed using the location of the selected region, represented by

$$\underline{{x}_{i}^{select}} and \overline{{x}_{i}^{select}} ,$$

and the subinterval indices of the subregion:

$$\underline{{x}_{i}^{( r )}} = \underline{{x}_{i}^{select}} + \frac{\overline{{x}_{i}^{select}} - \underline{{x}_{i}^{select}}}{4} \cdot {l}_{i}^{( r )} \qquad ( 12 )$$

$$\overline{{x}_{i}^{( r )}} = \underline{{x}_{i}^{select}} + \frac{\overline{{x}_{i}^{select}} - \underline{{x}_{i}^{select}}}{4} \cdot ( {l}_{i}^{( r )} + 1 ) \qquad ( 13 )$$

where i={1, 2} in this example. Of note, the example above with n=2 and k=16 is provided here for demonstration purposes only. In practice, the selected region is usually partitioned into at least thousands of subregions (i.e., t>1,000) to achieve high GPU occupancy, and the subinterval indices of each subregion are computed through a series of modulo and floor division operations when the objective function has more than two dimensions (i.e., n>2). Importantly, using the GPU-based SPSD parallel programming style, only limited data (2×n floating-point numbers) needs to be transferred from CPU to GPU constant memory, and all threads in GPU computing read the same data from GPU constant memory. When solving large-scale nonlinear optimization problems where GPU constant memory does not have enough space to store the location data of the selected region (e.g., n>4,000 with FP64 format), such location data could be transferred from CPU to GPU global memory. Because all threads in GPU computing read the same location data on GPU global memory, the data will be automatically cached on GPU, leading to minimal GPU global memory reads. After the execution of the kernel function, the subregions that are not labeled as suboptimal subregions (referred to as the “remaining subregions”) are transferred from GPU to CPU.

If there are many remaining subregions and each remaining subregion is represented by its location data, a large amount of data needs to be written onto GPU global memory and transferred to CPU (2×n floating-point numbers for each remaining subregion). To reduce GPU global memory writes and the amount of data that needs to be transferred from GPU to CPU, the index of each remaining subregion, Sidx, is written in an array on GPU global memory (one integer for each remaining subregion), and the array is transferred to CPU.

When solving large-scale nonlinear optimization problems, the selected region in the search domain is partitioned using a variable cycling technique, where the selected region is partitioned in a portion of its n dimensions in each iteration in a cyclic manner, significantly reducing the computational cost during the iteration process. If the selected region is partitioned in all its n dimensions in the kernel function, the number of subregions and the corresponding GPU computational cost increase exponentially with the dimension of the nonlinear function. To reduce the number of subregions that need to be analyzed during the execution of the kernel function, the selected region is partitioned in a portion of its n dimensions based on the cycling index of the selected region. For example, when solving a nonlinear optimization problem with n=1,000, 10 out of 1,000 dimensions of the selected region are partitioned in each iteration, and the range of each of these 10 variables is equally divided into four subintervals, while the ranges of the other n−10 variables are intact, resulting in 4¹⁰=1,048,576 subregions from the partition of the selected region in each iteration, aligned with the configuration and compute capability of a modern GPU for demonstration purposes.

At the first iteration, the single region that covers the whole search domain is assigned to a cycling index of 1, and the first 10 dimensions (x₁ to x₁₀) of the selected region are partitioned. The remaining subregions derived from the first iteration, where the global minimum must exist, are assigned to a cycling index of 11 when they are inserted into list L, and these regions will be partitioned in the next 10 dimensions (x₁₁ to x₂₀) if any of them is selected in the following iterations, and so on. If the selected region in an iteration has a cycling index of 991, the last 10 dimensions (x₉₉₁ to x₁₀₀₀) of the selected region are partitioned in the iteration. The remaining subregions derived from the iteration are assigned to a cycling index of 1 when they are inserted into list L, and these regions will be partitioned in the first 10 dimensions (x₁ to x₁₀) if any of them is selected in the following iterations. Importantly, using the variable cycling technique, a smaller number of regions needs to be partitioned during the whole iteration process, because many suboptimal regions where the global minimum cannot exist are ruled out before they are partitioned in all their n dimensions, significantly reducing the computational cost of the method when solving large-scale nonlinear optimization problems.

During the iteration process of the method, list L may contain a large number of regions (e.g., more than 1×10⁸ regions) where the global minimum must exist. To avoid host RAM overflow, only the following four types of data are stored in the host RAM for each region in list L: (1) Subregion index is the index of the subregion that is derived from the partition of the selected region, as shown in FIG. 3A, denoted by Sidx, and Sidx∈{0, 1, . . . , k−1}, where k is the total number of subregions derived from the partition of the selected region. The subregion index is stored in the host RAM as one integer; (2) Iteration index is the index of the iteration in which the subregion is derived from the partition of the selected region and inserted into list L, denoted by itr, and itr∈{0, 1, . . . , q−1}, where q is the total number of iterations of the method. The iteration index is stored in the host RAM as one integer; (3) Cycling index is the index that determines the specific dimensions of the region to be partitioned if the region is selected at the beginning of an iteration. The cycling index is stored in the host RAM as one integer; and (4) Lower bound for the value of the objective function in the region is computed by the interval evaluation of the objective function in the subregion using GPU computing. The lower bound for the value of the objective function in the region is stored in the host RAM as one floating-point number.

It is not necessary to store other types of data, such as the upper bound for the value of the objective function in each region and the location data of each region in list L, in the host RAM. List L with these four types of data could be realized through a dictionary-like data structure or multiple arrays. When a region is selected from list L at the beginning of an iteration, the location data of the selected region, represented by the lower and upper bounds for the value of each variable in the selected region (2×n floating-point numbers), is computed through the process illustrated in FIGS. 3(A-B) and implemented by Eqs. (10)-(13) on CPU, and the location data of the selected region in each iteration is stored in the host RAM.

To utilize the computational power of the GPU(s) efficiently, in each iteration of the method, the number of subregions derived from the partition of the selected region is determined based on the configuration and compute capability of the user's GPU(s). Specifically, this number is determined based on the total number of cores on the user's GPU(s) and the theoretical maximum number of active threads that could be supported by the user's GPU(s).

The method could be executed on multiple GPUs directly. When using multiple GPUs, in each iteration of the method, the number of subregions derived from the partition of the selected region is determined based on the total number of cores on all the GPUs and the theoretical maximum number of active threads that could be supported by all these GPUs.

A GPU-based numerical method to minimize or maximize nonlinear functions possibly subject to constraints on the variables has been disclosed herein. The method is realized through an iterative process that rules out the regions in the search domain where the global minimum or maximum cannot exist and leaves a finite set of regions where the global minimum or maximum must exist. The iteration process is designed and implemented based on GPU compute and memory architecture, where a GPU-based single program, single data parallel programming style is employed to circumvent major GPU performance bottlenecks, and a variable cycling technique is employed to reduce computational cost when solving large-scale nonlinear optimization problems. The method has been empirically shown to successfully enclose the global minimum of functions with up to 10,000 dimensions using only one GPU in a reasonable computation time.

The method is a complete and rigorous global optimization method that is guaranteed to enclose the global minimum or maximum within prescribed region size tolerances after a finite computation time, even in the presence of rounding errors. When solving a large-scale nonlinear optimization problem in practice, the total computation time of the method could be close to, or even less than, that of popular numerical optimization methods, especially gradient-based methods and heuristic methods. Importantly, although the method is more computationally expensive than popular numerical optimization methods in a single run, the users only need to run the method one time, while the users often have to run popular numerical optimization methods multiple times with different initial guesses and still do not know whether the best solution derived from these methods is the global minimum or maximum. The disclosed method also benefits from the rapid increase in both computational power and availability of GPU computing resources, and users can reduce the computation time using easily accessible GPU computing resources, such as a workstation with the latest GPU or a server with multiple GPUs.

The method may be implemented in software executing on a computer hardware with one or more GPUs. The computer hardware may include, in some embodiments, a typical laptop, desktop, workstation, superchip, and server with one or multiple GPUs couple thereto. The method and software implementing the method are tailored to take advantage of the computing capabilities of the GPU(s) and the major computational works are completed on the GPU(s). Based on the computer hardware, the results derived by computations performed on the GPU(s) may need to be transferred from the GPU(s) to the CPU after each iteration of the method, in which case the software may be executed on both the CPU and the GPU(s).

Finally, it is projected that the GPU-based numerical method can enclose the guaranteed global minimum or maximum of large-scale nonconvex nonlinear functions possibly subject to constraints on the variables, which have more than one million dimensions and many local minima or maxima using a GPU cluster in many practical applications. In addition, various sampling and partition strategies can be used to further improve the efficiency of the method.

As would be realized by one of skill in the art, many variations on implementations discussed herein which fall within the scope of the invention are possible. The invention is not meant to be limited to the particular exemplary embodiments disclosed herein. Moreover, it is to be understood that the features of the various embodiments described herein were not mutually exclusive and can exist in various combinations and permutations, even if such combinations or permutations were not made express herein, without departing from the spirit and scope of the invention. Accordingly, the specific methods disclosed herein are not to be taken as limitations on the invention but as an illustration thereof.

1. A system for enclosing the global minimum or maximum of an objective function comprising:
computer hardware including one or more GPUs; and
software, stored in memory of the computer hardware that, when executed by the computer hardware, iteratively performs the functions of:
selecting one region from a list of regions that may include the global minimum or maximum;
updating an upper bound of the global minimum when the objective function is minimized or updating the lower bound of the global maximum when the objective function is maximized;
eliminating one or more suboptimal regions from the list.
partitioning the selected region into a plurality of subregions, and eliminating the subregions that are suboptimal; and
inserting the remaining subregions into the list for the next iteration.

2. The system of claim 1 further comprising:
eliminating one or more suboptimal regions from the list;
wherein when the objective function is minimized, the suboptimal region has a lower bound for the value of the objective function in the region that is larger than the upper bound of the global minimum; and
wherein when the objective function is maximized, the suboptimal region has an upper bound for the value of the objective function in the region that is smaller than the lower bound of the global maximum.

3. The system of claim 1 wherein the computer hardware includes a CPU, coupled to the one or more GPUs and the memory.

4. The system of claim 1 wherein, in the first iteration, the list comprises a single region covering the entire search domain for minimizing or maximizing the objective function.

5. The system of claim 1 wherein the selected region for each iteration is selected based on a criterion selected from a group consisting of a region having a smallest lower bound for a value of the objective function when the objective function is minimized or a region having a largest upper bound for the value of the objective function when the objective function is maximized, the first region in the list, the last region in the list, and a randomly picked region in the list.

6. The system of claim 1 wherein the upper bound of the global minimum (when the objective function is minimized) or the lower bound of the global maximum (when the objective function is maximized) is updated using a technique selected from a group consisting of selecting sampling points over the selected region, selecting sampling points over the entire search domain, selecting sampling points over one or more regions in the list, using the upper bound(s) for the value of the objective function in one or more region(s) in the search domain (when the objective function is minimized), and using the lower bound(s) for the value of the objective function in one or more region(s) in the search domain (when the objective function is maximized).

7. The system of claim 6 wherein the sampling points are selected using a technique selected from a group consisting of random sampling, diagonal sampling, simple grids, maximum entropy designs, mean squared-error designs, Latin hypercubes, and randomized orthogonal arrays.

8. The system of claim 6 wherein the sampling points are selected by minimizing or maximizing the objective function subject to any constraints on the variables in the region and using the solutions as sample points.

9. The system of claim 1 wherein the partitioning is based on a user-specified partitioning strategy.

10. The system of claim 9 wherein the partitioning strategy is uniform partitioning or golden ratio partitioning.

11. The system of claim 1 wherein the suboptimal subregions are eliminated based on the evaluations of the objective and any constraint functions within these subregions using interval analysis.

12. The system of claim 1 wherein the suboptimal subregions are eliminated using the upper bound of the global minimum when the objective function is minimized or the lower bound of the global maximum when the objective function is maximized, constraint satisfaction, and the first-order derivatives of the objective function in these subregions.

13. The system of claim 1 wherein the iteration is stopped when one or more stopping criteria are met at the end of an iteration.

14. The system of claim 13 wherein the stopping criteria are user-specified.

15. The system of claim 13 wherein the stopping criteria are selected from a group consisting of one or more of a maximum runtime, maximum iterations and regions size tolerance.

16. The system of claim 13 wherein, after the stopping criteria have been met, the minimum or maximum of the objective function is guaranteed to be enclosed within one of the remaining regions in the list.

17. The system of claim 13 wherein, after the stopping criteria have been met, the minimum or maximum of the objective function is guaranteed to be enclosed within an interval comprising an upper bound and a lower bound.

18. The system of claim 1 wherein inserting the remaining subregions into the list comprises:
combining some or all remaining regions as one or multiple regions based on a user-specified combination criterion.

19. The system of claim 17 wherein:
when the objective function is minimized, the lower bound is the smallest lower bound for the value of the objective function in all regions in the list and the upper bound is the updated upper bound of the global minimum derived in the last iteration; and
when the objective function is maximized, the lower bound is the updated lower bound of the global maximum derived in the last iteration and the upper bound is the largest upper bound for the value of the objective function in all regions in the list.

20. The system of claim 1 wherein each thread in parallel computing executed on the one or more GPUs evaluates the objective and any constraint functions in one or more subregions independently using interval analysis.

21. The system of claim 20 wherein the evaluation of the objective and any constraint functions in each GPU thread is controlled by a kernel function customized to the GPU compute and memory architecture.

22. The system of claim 20 wherein the plurality of subregions into which the selected region is partitioned is determined based on the configuration and compute capability of the one or more GPUs.

23. The system of claim 20 wherein the partitioning is performed to yield a number of subregions such as to approach full occupancy of the one or more GPUs.

24. The system of claim 21 wherein the kernel function is implemented using a GPU-based single program, single data parallel programming style, wherein threads in GPU computing read the same data from GPU memory.

25. The system of claim 21 wherein the kernel function is implemented using a GPU-based single program, single data parallel programming style, wherein the parallel computing of the threads in the same warp belongs to the single instruction stream, single data stream (SISD) class.

26. The system of claim 21 wherein the bounds of each subregion are computed using the bounds of the selected region and the index of the corresponding GPU thread in threads of GPU computing.
